(19) United States
(12) Patent Application Publication
(10) Pub. No.: US 2026/0263995 A1
(43) Pub. Date: Sep. 10, 2026

(54) ROTARY-BED DEVICE

(71) Applicant: IFP Energies nouvelles, Rueil-Malmaison (FR)

(72) Inventors: Philippe BÉARD, Rueil-Malmaison Cedex (FR); Samy LAABIDI, Rueil-Malmaison Cedex (FR); Marine MINIERE, Rueil-Malmaison Cedex (FR); Véronique PENIN, Rueil-Malmaison Cedex (FR); Thibault STHEME DE JUBECOURT, Rueil-Malmaison Cedex (FR)

(73) Assignee: IFP Energies nouvelles, Rueil-Malmaison (FR)

(21) Appl. No.: 19/560,322

(22) Filed: Mar. 9, 2026

(30) Foreign Application Priority Data
Mar. 10, 2025 (FR) 25/02.343

(51) Int. Cl. B01D 53/18; B01D 53/14; B01D 53/52; B01D 53/62; B01D 53/78

(52) U.S. Cl. CPC B01D 53/185; B01D 53/1468; B01D 53/1475; B01D 53/52; B01D 53/62; B01D 53/78; B01D 2257/304; B01D 2257/504; B01D 2258/0283

(57) ABSTRACT

A rotary-bed device comprises:
an inlet for a first fluid,
an inlet for a second fluid,
an outlet for the first fluid,
an outlet for the second fluid,
a rotary contactor comprising a rotary shaft and a packed bed secured to the rotary shaft,
a flow channel for the second fluid, configured to make the second fluid flow from the packed bed to the outlet for the second fluid, and
a housing to receive the rotary shaft.

The flow channel for the second fluid is arranged in a space radially to the outside of the rotary shaft and radially to the inside of the housing receiving the rotary shaft.

### TECHNICAL FIELD

The present invention relates to the field of rotary-contactor equipment. Such equipment is frequently used in chemical engineering, for a wide variety of industrial processes. This equipment makes it possible to transfer material, or heat, between two fluids that have been brought into contact by virtue of the dispersion implemented by a rotary contactor.

### PRIOR ART

Rotary-contactor equipment has advantages over similar fixed-bed equipment. The centrifugal force experienced by the fluids owing to the rotation of the bed of the rotary contactor improves the efficiency of transfer between the two fluids. For the same treatment capacity, a piece of rotary-contactor equipment is thus more compact and weighs less than a similar piece of fixed-bed equipment. Less material is therefore used to manufacture the equipment, which generally makes the latter a more economical and also a more environmentally friendly solution. In addition, it is easier to install, in particular at sites where the space available is limited.

Some processes, such as capturing CO2 from combustion effluents from a factory, or from a thermal power plant, require a much higher treatment capacity than what conventional rotary-contactor equipment can provide. This increase in capacity can be obtained by simply increasing the size of the equipment. However, simply increasing the size of conventional equipment generally leads to a drop-in efficiency, and causes the equipment to lose some of its advantages.

There is therefore a need to provide rotary-contactor equipment that is optimized for a large treatment capacity.

### SUMMARY

To this end, the invention proposes a rotary-bed device, comprising:
at least one inlet for a first fluid,
at least a first inlet/outlet for a second fluid,
at least one outlet for the first fluid,
at least a second inlet/outlet for the second fluid,
a rotary contactor, comprising:
a rotary shaft,
a packed bed, secured to the rotary shaft, and configured to allow a transfer of material and/or transfer of heat between the first fluid and the second fluid,
at least one flow channel for the second fluid, configured to make the second fluid flow from the packed bed to said at least one second inlet/outlet for the second fluid or to make the second fluid flow from said at least one second inlet/outlet for the second fluid to the packed bed,
at least a housing to receive the rotary shaft,

wherein said at least one flow channel for the second fluid is arranged in a space radially to the outside of the rotary shaft and radially to the inside of the housing receiving the rotary shaft of the rotary contactor.

By situating the flow channel for the second fluid in the space lying between the rotary shaft itself and the housing in which the rotary shaft is received, a large flow cross section can be offered to the second fluid, making it possible to reduce the drop in pressure that the flow of the second fluid experiences. This improves the performance of the rotary-bed device. In particular, the treatment capacity is increased for the same size of the rotary-bed device.

In a variant, the rotary shaft is configured to pivot with respect to the housing by means of at least one rolling bearing arranged in the housing,
and said at least one rolling bearing is arranged in said at least one flow channel for the second fluid notably in such a way as to lubricate and/or cool said rolling bearing.

Note that the rolling bearing is one example of the bearing and that, in the present text, where technically feasible, where mention is made of a rolling bearing, any other type of guide bearing may be considered.

In another variant, the housing comprises a first wall forming a retaining housing for a guide bearing for the rotary shaft and a second wall radially to the outside of the first wall, and said at least one flow channel for the second fluid is arranged in part in a space radially to the outside of the first wall of the housing and radially to the inside of the second wall of the housing, thereby making it possible to avoid or at the very least to limit the corrosion or the fouling of said rolling bearing by said second fluid.

The features listed in the following paragraphs can be implemented independently of one another or in any technically feasible combination:

According to one embodiment, the at least one first inlet/outlet for the second fluid is an inlet, and the at least one second inlet/outlet for the second fluid is an outlet. In other words, the second fluid is admitted into the rotary-bed device through the at least one first inlet/outlet, and leaves the rotary-bed device through the at least one second inlet/outlet.

The at least one first inlet/outlet is configured to receive a flow of a second fluid, and the at least one second inlet/outlet is configured to provide a flow of the second fluid.

The second fluid flows in the flow channel in a first flow direction.

According to another embodiment, the at least one first inlet/outlet for the second fluid is an outlet, and the at least one second inlet/outlet for the second fluid is an inlet.

According to another exemplary embodiment of the rotary-bed device, the packed bed allows material of at least a certain component of the first fluid to be transferred to the second fluid.

According to one exemplary embodiment, the first fluid is a liquid. The second fluid is a gas.

According to another exemplary embodiment, the first fluid is a liquid, and the second fluid is also a liquid.

A “liquid” is understood as meaning an entirely liquid phase, or a phase possibly also containing solid particles or gas bubbles in suspension. This term also encompasses a plurality of mutually immiscible phases (two for example).

The first fluid and the second fluid can flow in a counter-current arrangement, i.e. in substantially parallel directions and opposite directions of movement. The two fluids flow in the packed bed of the rotary contactor in a radial direction.

The at least one flow channel for the second fluid makes the second fluid flow from the packed bed towards the at least one second inlet/outlet for the second fluid.

The flow of the first fluid and of the second fluid can be of the co-current type, i.e. in substantially parallel directions and one same flow direction. The two fluids flow in the packed bed of the rotary contactor in a radial direction.

In this case, the at least one flow channel for the second fluid makes the second fluid flow from the second inlet/outlet for the second fluid towards the packed bed.

The flow of the first fluid and of the second fluid can be of the cross-current type, i.e. in transverse directions of movement.

The first fluid flows in the packed bed of the rotary contactor in a radial direction. The second fluid flows in the packed bed in an axial direction.

The rotary shaft is a solid shaft.

The at least one flow channel for the second fluid is of cylindrical shape.

The rotary-bed device comprises an enclosure which forms a support member for holding the rotary contactor.

The housing in which the rotary shaft is arranged is formed in the enclosure.

The enclosure is fixed.

The enclosure is fluidtight.

A portion of at least one flow channel for the second fluid extends axially between the packed bed and a first axial end of the rotary shaft.

According to one embodiment of the rotary-bed device, the at least one flow channel for the second fluid and the rotary shaft are coaxial.

The rotary shaft is configured to pivot relative to the enclosure by means of at least one guide bearing.

According to one embodiment of the rotary-bed device, the rotary shaft is configured to pivot with respect to the housing by means of at least one rolling bearing arranged in the housing,
and said at least one rolling bearing is arranged in said at least one flow channel for the second fluid. In other words, the guide bearing for the rotary shaft is, for example, a rolling bearing.

In instances in which the guide bearing is a rolling bearing, the moving parts of the rolling bearing may be in contact with the second fluid when the rotary-bed device is in operation. The second fluid then contributes to cooling the rolling bearing, making it possible to reduce the thermal stresses on the components of the rolling bearing. For certain chemical compositions of the second fluid, the circulation of the second fluid also provides lubrication for the rolling bearing, thus improving its reliability.

According to one embodiment of the rotary-bed device, the rolling bearing comprises:
an inner ring in which the rotary shaft is arranged,
an outer ring arranged in the housing,
   and a portion of the at least one flow channel extends radially between the rotary shaft and the housing.

A portion of the at least one flow channel extends axially between a first axial end of the at least one rolling bearing and a second axial end of the at least one rolling bearing and extends radially between the inner ring and the outer ring of the at least one rolling bearing.

In other words, the space axially comprised between a first axial end of the at least one rolling bearing and a second axial end of the at least one rolling bearing, and comprised radially between the inner ring and the outer ring, forms a portion of the at least one flow channel.

According to one embodiment of the rotary-bed device, the housing comprises a first wall forming a retaining housing for a guide bearing for the rotary shaft and a second wall radially to the outside of the first wall, and
said at least one flow channel for the second fluid is arranged in part in a space radially to the outside of the first wall of the housing and radially to the inside of the second wall of the housing.

In other words, in this embodiment, part of the flow channel for the second fluid passes around the guide bearing for the rotary shaft.

The second fluid is therefore not in contact with the guide bearing, thereby notably avoiding degradation of this guide bearing when the second fluid is corrosive.

According to one aspect of the rotary-bed device, the rotary contactor comprises:
a first end plate and a second end plate, the first end plate and the second end plate extending transversely with respect to the rotary shaft, some distance apart from one another, the first end plate being secured to the rotary shaft,
a mixing chamber delimited in an axial direction by the two end plates, the packed bed being arranged in the mixing chamber,

and the first end plate comprises at least one through-orifice configured to allow fluid to pass between the packed bed and said at least one flow channel for the second fluid.

The mixing chamber is filled by the packed bed.

The two end plates form a support, in an axial direction, for the packed bed.

According to one aspect of the rotary-bed device, the mixing chamber comprises a radially inner edge and a radially outer edge, and is configured to allow the first fluid to flow from the radially inner edge towards the radially outer edge.

According to one embodiment, the mixing chamber is configured to allow the second fluid to flow from the radially outer edge towards the radially inner edge.

According to another embodiment, the mixing chamber is configured to allow the second fluid to flow from the radially inner edge towards the radially outer edge.

The at least one through-orifice of the first end plate opens into the at least one flow channel for the second fluid.

A radially inner edge of the at least one through-orifice of the first end plate is adjacent to the rotary shaft.

The first end plate comprises a set of through-orifices.

The through-orifices of the first end plate may be uniformly spaced.

The through-orifices of the first end plate are arranged at the same distance from the centre of the first end plate.

The through-orifices of the first end plate may have the same shape.

The through-orifices of the first end plate are bounded laterally by two rectilinear portions.

The through-orifices of the first end plate are bounded radially by two circular-arc portions. The two circular-arc portions have the same centre and this centre coincides with the centre of the first end plate.

Each rectilinear portion extends radially towards the centre of the first end plate.

According to one embodiment, the rotary-bed device comprises:
a third inlet/outlet for the second fluid,
a second flow channel configured to make the second fluid flow from the packed bed towards the third inlet/outlet for the second fluid, or to make the second fluid flow from the third inlet/outlet towards the packed bed.

The presence of a second flow channel makes it possible to increase the flow cross section for the second fluid, and thus further reduce the drop in pressure. For the same amount of occupied space, the maximum flow rate of the rotary-bed device can be increased.

The third inlet/outlet for the second fluid has the same role as the second inlet/outlet. In other words, according to one embodiment, the second inlet/outlet and the third inlet/outlet are both inlets for the second fluid.

According to another embodiment, the second inlet/outlet and the third inlet/outlet are both outlets for the second fluid.

According to one embodiment of the rotary-bed device,
the second end plate comprises at least one through-orifice configured to allow fluid to pass between the packed bed and the second flow channel for the second fluid.

The second flow channel for the second fluid is of cylindrical shape.

The first flow channel and the second flow channel are arranged in an axial direction one on each side of the mixing chamber.

The first flow channel and the second flow channel are coaxial.

According to one embodiment of the rotary-bed device, the rotary shaft is configured to pivot relative to the enclosure by means of a single guide bearing. This single guide bearing may be a rolling bearing.

According to one embodiment, the rotary-bed device comprises a second housing for receiving the rotary shaft,
and the second flow channel for the second fluid is arranged in a space radially to the outside of the rotary shaft and radially to the inside of the second housing for receiving the rotary shaft of the rotary contactor.

According to one embodiment, the rotary shaft is configured to pivot relative to the enclosure by means of at least a first guide bearing and a second guide bearing.

According to one embodiment of the rotary-bed device, the rotary shaft is configured to pivot with respect to the second housing by means of a second rolling bearing arranged in the second housing,
and the second rolling bearing is arranged in the second flow channel for the second fluid. In other words, the second guide bearing for the rotary shaft may be a rolling bearing.

The second rolling bearing improves the guidance of the rotary shaft.

Likewise, the housing in which the second rolling bearing is arranged is formed in the enclosure.

According to one embodiment of the rotary-bed device, the first rolling bearing and the second rolling bearing are arranged in an axial direction one on each side of the mixing chamber.

The rotary-bed device may thus exhibit symmetry about a plane transverse to the axis of the rotary shaft. This makes it easier for the second fluid to flow.

The second rolling bearing and the first rolling bearing may be identical.

According to one aspect of the rotary-bed device, the second rolling bearing comprises:
an inner ring in which the rotary shaft is arranged,
an outer ring arranged in the second housing,

and a portion of the second flow channel extends radially between the rotary shaft and the second housing.

The second outlet channel for the second fluid is coaxial with the rotary shaft.

According to one embodiment, the first flow channel for the second fluid and the second flow channel for the second fluid are coaxial.

According to one embodiment of the rotary-bed device, the second housing comprises a first wall forming a retaining housing for a second guide bearing for the rotary shaft and a second wall radially to the outside of the first wall, and
the second flow channel for the second fluid is arranged in part in a space radially to the outside of the first wall of the second housing and radially to the inside of the second wall of the second housing.

As previously, part of the second flow channel for the second fluid passes around the second guide bearing for the rotary shaft.

The second guide bearing is therefore not in contact with the second fluid, thereby notably avoiding degradation when the second fluid is corrosive.

The first flow channel for the second fluid and the second flow channel for the second fluid are in fluidic communication.

According to one embodiment of the rotary-bed device, the second end plate is secured to the rotary shaft.

The at least one through-orifice of the second end plate opens into the second flow channel for the second fluid.

A radially inner edge of the at least one through-orifice of the second end plate is adjacent to the rotary shaft.

The through-orifices of the second end plate may have the same shape as the through orifices of the first end plate.

The through-orifices of the second end plate may have the same flow cross section as the through-orifices of the first end plate.

According to one embodiment of the rotary-bed device, the rotary contactor comprises:
a first end plate and a second end plate, the first end plate and the second end plate extending transversely with respect to the rotary shaft, some distance apart from one another, the first end plate being secured to the rotary shaft,
a mixing chamber delimited in an axial direction by the two end plates, the packed bed being arranged in the mixing chamber, and:
the first end plate comprises at least one through-orifice configured to allow fluid to pass between the at least one first inlet/outlet for the second fluid and the packed bed, and
the second end plate comprises at least one through-orifice configured to allow fluid to pass between the packed bed and said at least one flow channel for the second fluid.

The set of through-orifices of the first end plate is arranged on a first lateral surface of the packed bed. The set of through-orifices of the second end plate is arranged on a second lateral surface of the packed bed, this being the opposite surface to the first lateral surface.

According to one embodiment of the rotary-bed device, the rotary contactor comprises:
a rotary shaft,
a first packed bed, secured to the rotary shaft, and configured to allow a transfer of material or a transfer of heat between the first fluid and the second fluid,
a second packed bed, secured to the rotary shaft, and configured to allow a transfer of material or a transfer of heat between the first fluid and the second fluid, an outlet of the first packed bed being configured to supply a flow of the first fluid to the second packed bed,
an outlet of the second packed bed being configured to supply a flow of the second fluid to the first packed bed,
a first flow channel for the second fluid, configured to make the second fluid flow from the first packed bed towards the second inlet/outlet for the second fluid,
a second flow channel for the second fluid, configured to make the second fluid flow from the second packed bed towards the first packed bed,
at least a housing to receive the rotary shaft,

wherein said at least one second flow channel for the second fluid is arranged in a space radially to the outside of the rotary shaft and radially to the inside of the housing receiving the rotary shaft of the rotary contactor.

According to one embodiment, the rotary-bed device comprises at least one distributor for the first fluid, configured to transfer the first fluid from the inlet for the first fluid to the packed bed, and a portion of said at least one distributor for the first fluid is arranged inside the rotary shaft of the rotary contactor.

According to one embodiment of the rotary-bed device, the at least one distributor comprises a tubular portion, and the tubular portion of said at least one distributor and the rotary shaft of the rotary contactor are coaxial.

The at least one distributor comprises at least one through-orifice for the first fluid.

The at least one distributor comprises a set of through-orifices for the first fluid.

The at least one distributor comprises a tubular portion.

The at least one through-orifice for the first fluid is formed in a side wall of the tubular portion.

The at least one through-orifice is arranged facing the packed bed in a radial direction.

The through-orifices are axially offset along the tubular portion of the distributor.

The through-orifices are angularly offset along a part of the lateral surface of the tubular portion.

According to one exemplary embodiment, the end of the tubular portion of the at least one distributor for the first fluid is closed.

According to another exemplary embodiment, the end of the tubular portion of the at least one distributor for the first fluid is open.

The rotary-bed device can comprise two distributors.

The two distributors are for example arranged parallel to one another inside the rotary contactor.

According to another exemplary embodiment of the rotary-bed device, the rotary shaft is oriented in a horizontal direction.

The at least one first inlet/outlet for the second fluid is arranged on a side face of the enclosure.

The outlet for the first fluid and the at least one second inlet/outlet for the second fluid extend in perpendicular planes.

According to one embodiment, the outlet for the first fluid is arranged in a lower portion of the enclosure.

A lower portion of the enclosure forms a collection volume for the first fluid.

The inlet for the second fluid is arranged in a portion of the enclosure arranged facing an end plate of the rotary contactor.

According to one exemplary embodiment of the rotary-bed device, the rotary shaft is oriented in a vertical direction.

The rotary shaft can form any angle with the vertical axis.

The rotary-bed device comprises a first seal arranged in an axial direction between the first end plate of the rotary contactor and the enclosure.

The first seal surrounds the at least one flow channel.

The rotary-bed device comprises a second seal arranged in an axial direction between the second end plate of the rotary contactor and the enclosure.

The second seal surrounds the second outlet channel.

According to one embodiment, the rotary-bed device comprises a third seal arranged radially between a portion of the rotary shaft and part of the enclosure.

Another subject of the invention is any method for implementing the rotary-bed device described above, in which material and/or heat is/are transferred from one of the two fluids to the other fluid, the two fluids notably both being liquid (or predominantly liquid even though they may contain a solid phase/solid particles or gas bubbles in suspension), or one being liquid and the other gaseous.

The device according to the invention thus has multiple applications, including any type of liquid-liquid extraction.

Two notable applications for the device according to the present invention include, nonlimitingly:

One application in which the invention has an interest, without the invention being restricted to this application, is the deacidification of gaseous effluent such as, for example, natural gas, synthesis gases, combustion flue gases, refinery gases, tail gases from the Claus process, biomass fermentation gases. The deacidification is carried out by washing with an absorbent liquid solution, with the acid compound being transferred from the gaseous effluent to this absorbent solution. The absorbent solution makes it possible to absorb the acidic compounds present in the gaseous effluent, such as notably hydrogen sulfide H2S, mercaptans, carbon dioxide CO2, sulfur dioxide SO2, carbonyl sulfide COS and carbon disulfide CS2. The physicochemical characteristics of this absorbent solution are related to the nature of the gas to be treated: expected specification for the treated gas, selective removal of an acidic compound, thermal and chemical stability of the solution with respect to the various compounds present in the gaseous effluent to be treated. Of more particular interest in this case is the treatment of gaseous effluents with a view to capturing the carbon dioxide CO2 that they contain, the capture of CO2 by solvent being one of the ways of reducing the industrial emissions of CO2 and of limiting the accumulation of this greenhouse gas in the atmosphere.

The other application, connected with the previous one, concerns the regeneration of these absorbent liquids, by bringing into contact with, for example, stripping gas which will see the acidic compounds released by the solution, notably through the effect of the application of heat, this time with material being transferred from the liquid solution to a gas or gas mixture.

### BRIEF DESCRIPTION OF THE DRAWINGS

Further features, details and advantages will become apparent from reading the detailed description hereinafter, and from studying the attached drawings, in which:

FIG. 1 is a schematic representation, from the side and in section, of a rotary-bed device according to a first embodiment,

FIG. 2 is a schematic representation, from the side and in section, of a rotary-bed device according to a second embodiment,

FIG. 3 is a schematic representation, from the side and in section, of a rotary-bed device according to a third embodiment,

FIG. 4 is a schematic representation, from the side and in section, of a rotary-bed device according to a fourth embodiment,

FIG. 5 is a schematic representation, from the side and in section, of the rotary contactor of a first variant of the rotary-bed device of FIGS. 1 to 3,

FIG. 6 is a schematic representation, from the side and in section, of a rotary-bed device according to a fifth embodiment,

FIG. 7 is a schematic representation, from the side and in section, of a rotary-bed device according to a fifth embodiment,

FIG. 8 is a schematic representation, from the side and in section, of a rotary-bed device according to a sixth embodiment.

### DESCRIPTION OF THE EMBODIMENTS

In order to make it easier to read the figures, the various elements are not necessarily shown to scale. In these figures, identical elements bear the same references. Certain elements or parameters may be indexed, which is to say designated for example as first element or second element, or else as first parameter and second parameter, etc. This indexing is intended to differentiate between elements or parameters that are similar but not identical. This indexing does not imply that one element or parameter takes priority over another and the denominations may be interchanged.

Where it is specified that a device comprises a given element, that does not exclude there being other elements present in that device.

In the various figures, the axis Z represents the vertical direction, the arrow pointing upwards. The axis X represents a horizontal axis.

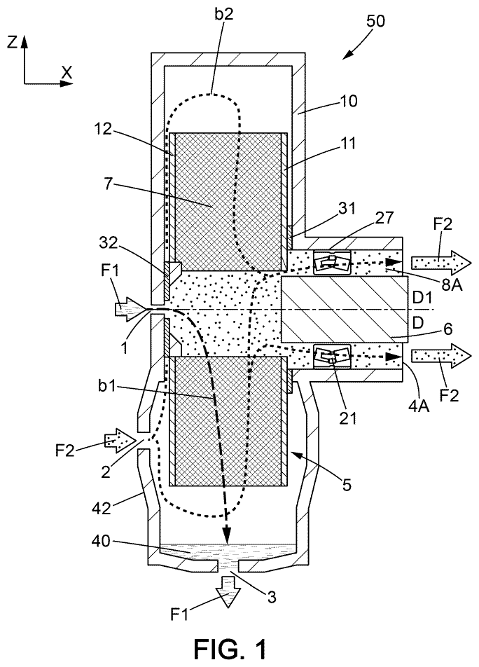

FIG. 1 schematically represents a rotary-bed device 50 according to a first embodiment.

The rotary-bed device 50 comprises:
at least one inlet 1 for a first fluid F1,
at least a first inlet/outlet 2 for a second fluid F2,
at least one outlet 3 for the first fluid F1,
at least a second inlet/outlet 4A for the second fluid F2,
a rotary contactor 5.

The rotary contactor 5 comprises:
a rotary shaft 6,
a packed bed 7 which is secured to the rotary shaft 6 and configured to allow a transfer of material or a transfer of heat between the first fluid F1 and the second fluid F2.

The rotary-bed device 50 comprises at least one flow channel 8A for the second fluid F2, configured to make the second fluid F2 flow from the packed bed 7 to said at least one second inlet/outlet 4A for the second fluid F2 or to make the second fluid F2 flow from said at least one second inlet/outlet 4A for the second fluid F2 to the packed bed 7.

The rotary-bed device 50 comprises at least a housing 27 to receive the rotary shaft 6, and said at least one circulation channel 8A for the second fluid F2 is arranged in a space radially to the outside of the rotary shaft 6 and radially to the inside of the housing 27 receiving the rotary shaft 6 of the rotary contactor 5.

What is meant by “radially to the outside” is the space surrounding the rotary shaft, namely the zone lying at a greater distance from the axis of rotation than the surface of the rotary shaft. What is meant by “radially to the inside” is the space surrounded by the receiving housing, namely the zone lying at a shorter distance from the axis of rotation than the surface of the receiving housing.

By situating the flow channel 8A for the second fluid F2 in the space lying between the rotary shaft 6 itself and the housing 27 in which the rotary shaft 6 is received, a large flow cross section can be offered to the second fluid F2. The drop in pressure that the flow of the second fluid F2 experiences can thus be reduced. This improves the performance of the rotary-bed device 50. In particular, the treatment capacity is increased for the same size of the rotary-bed device 50.

According to a first embodiment, illustrated in FIG. 1, the at least one first inlet/outlet 2 for the second fluid F2 is an inlet, and the at least one second inlet/outlet 4A for the second fluid F2 is an outlet.

In other words, the second fluid F2 is admitted into the rotary-bed device 50 through the at least one first inlet/outlet 2, and leaves the rotary-bed device 50 through the at least one second inlet/outlet 4A. The flow channel 8A is in this case an outlet channel for the second fluid F2. The at least one first inlet/outlet 2 is thus configured to receive a flow of a second fluid F2, and the at least one second inlet/outlet 4A is configured to supply a flow of the second fluid F2. The second fluid F2 flows in the flow channel 8A in a first flow direction.

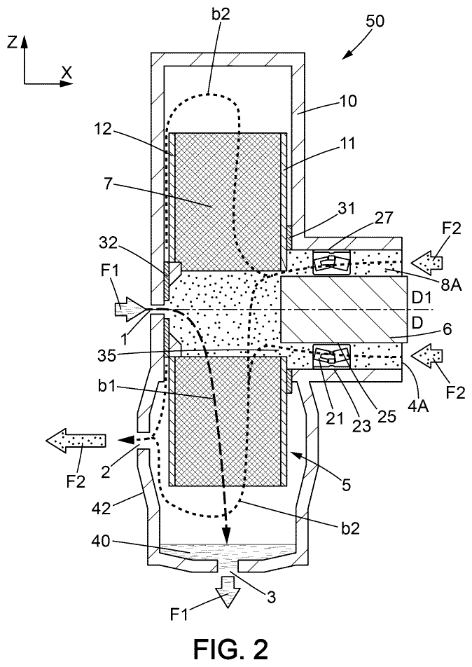

FIG. 2 depicts a second embodiment of the rotary-bed device 50.

According to this second embodiment, the at least one first inlet/outlet 2 for the second fluid F2 is an outlet, and the at least one second inlet/outlet 4A for the second fluid F2 is an inlet. In other words, the second fluid F2 is admitted into the rotary-bed device 50 through the at least one second inlet/outlet 4A, and leaves the rotary-bed device 50 through the at least one first inlet/outlet 2. The flow channel 8A is, according to this embodiment, an inlet channel for the second fluid F2.

The at least one second inlet/outlet 4A is thus configured to receive a flow of the second fluid F2, and the at least one first inlet/outlet 2 is configured to supply a flow of the second fluid F2. The second fluid F2 flows in the flow channel 8A in a second flow direction counter to the first flow direction.

The at least one inlet 1 is configured to receive a flow of a first fluid F1. The at least one outlet 3 is configured to supply a flow of the first fluid F1.

The first fluid F1 and the second fluid F2 are in contact with one another as they flow in the packed bed 7 of the rotary contactor 5.

The centrifugal force generated by the rotation of the rotary contactor 5 makes it possible to force the first fluid F1 to migrate from the radially inner part of the packed bed 7 to the radially outer part of the packed bed 7. The centrifugal force makes it possible to improve the efficiency of the transfer between the two fluids F1, F2, thereby increasing the treatment capacity, or makes it possible to reduce the quantity of packed bed used in the rotary contactor.

According to an exemplary embodiment of the rotary-bed device 50, the packed bed 7 allows material of at least a certain component of the second fluid F2 to be transferred to the first fluid F1.

According to another exemplary embodiment of the rotary-bed device 50, the packed bed 7 allows material of at least a certain component of the first fluid F1 to be transferred to the second fluid F2.

If material is transferred, the chemical composition of the first fluid F1 changes as the first fluid flows through the packed bed 7. Similarly, the chemical composition of the second fluid F2 changes as the second fluid flows through the packed bed 7.

As a result, the chemical composition of the first fluid F1 at the outlet 3 of the rotary-bed device 50 differs from the chemical composition of the first fluid F1 at the inlet 1 of the rotary-bed device 50.

In the same way, the chemical composition of the second fluid F2 at the outlet 4A of the rotary-bed device 50 differs from the chemical composition of the second fluid F2 at the inlet 2 of the rotary-bed device 50.

If heat is transferred, the temperature of the first fluid F1 changes as the first fluid flows through the packed bed 7. The temperature at the outlet differs from the temperature at the inlet. Similarly, the temperature of the second fluid F2 changes as the second fluid flows through the packed bed 7.

The first fluid F1 may comprise particles. The particles may be present in the first fluid F1 at the inlet of the rotary-bed device 50, at the outlet of the rotary-bed device 50, or at both the inlet and the outlet of the rotary-bed device 50.

Similarly, the second fluid F2 may also comprise particles. As above, the particles may be present in the second fluid F2 at the inlet of the rotary-bed device 50, at the outlet, or at both the inlet and the outlet of the rotary-bed device 50.

According to the example illustrated, the first fluid F1 is a liquid. The second fluid F2 is a gas.

The liquid can absorb one or more chemical compounds present in the gas.

One exemplary application is the capture of CO2 from the flue gases from a factory.

Another exemplary application is the removal of hydrogen sulfide from a gaseous effluent. The liquid forms an absorbent solution.

In the case of the capture of CO2, the second fluid F2 is a gaseous mixture containing CO2 (carbon dioxide).

The first fluid F1 is for example a liquid solution completely or partially comprising a compound that reacts with CO2, making it possible to absorb the latter. This or these reactive compound(s) can be pure, diluted and in the form of an ionic liquid. They are selected from the group made up of amines, alkanolamines, azoles, ketones, oximes, lactams, enols, alcohols, thiols, amino acids, alkali metal salts of amino acids, amides, ureas, phosphates, carbonates or borates of alkali metals.

The following list provides a few examples of reactive compounds that can be used: N, N,4-trimethyl-1-piperazinepropanamine; 1,2-bis(dimethylaminoethoxy)ethane; 2-[(2-hydroxyethyl)amino]-2-methyl-1-propanol; 2-[(2-hydroxypropyl)amino]-2-methyl-1-propanol.

The liquid solution may comprise a mass fraction of the nitrogen compound of between 10% and 100% by weight, and a mass fraction of water of between 0% and 90% by weight, the sum of the mass fractions of water and the nitrogen compound being greater than or equal to 50%. The second fluid F2 is unprocessed at the inlet of the rotary-bed device, and is purified at the outlet.

The first fluid F1 is depleted at the inlet of the rotary-bed device, and enriched at the outlet.

According to another exemplary embodiment (not depicted), the first fluid F1 is a liquid, and the second fluid F2 is also a liquid.

Different types of flow of the first fluid F1 and the second fluid F2 are possible. In the different figures, the dashed line denoted by the sign b1 schematically shows the path taken by the first fluid F1.

The dashed line denoted by the sign b2 schematically shows the path taken by the second fluid F2. The arrows schematically show the direction of the path taken.

The first fluid F1 and the second fluid F2 can flow in a counter-current arrangement, i.e. in substantially parallel directions and opposite directions of movement. The two fluids F1, F2 flow in the packed bed 7 of the rotary contactor 5 in a radial direction.

As depicted in FIG. 1, the first inlet/outlet 2 is in this case an inlet and the second inlet/outlet 4A is an outlet.

The at least one flow channel 8A for the second fluid F2 makes the second fluid F2 flow from the packed bed 7 to the at least one second inlet/outlet 4A for the second fluid F2.

According to another embodiment, illustrated in FIG. 2, the flow of the first fluid F1 and of the second fluid F2 can be of the co-current type, i.e. in substantially parallel directions and one same flow direction.

The two fluids F1, F2 flow in the packed bed 7 of the rotary contactor 5 in a radial direction. In this case, the second inlet/outlet 4A is an inlet and the first inlet/outlet 2 is an outlet.

The at least one flow channel 8A for the second fluid F2 in this case makes the second fluid F2 flow from the second inlet/outlet 4A for the second fluid F2 to the packed bed 7.

The second embodiment thus differs from the first embodiment by the flow direction of the second fluid F2.

The flow of the first fluid F1 remains unchanged between the two embodiments.

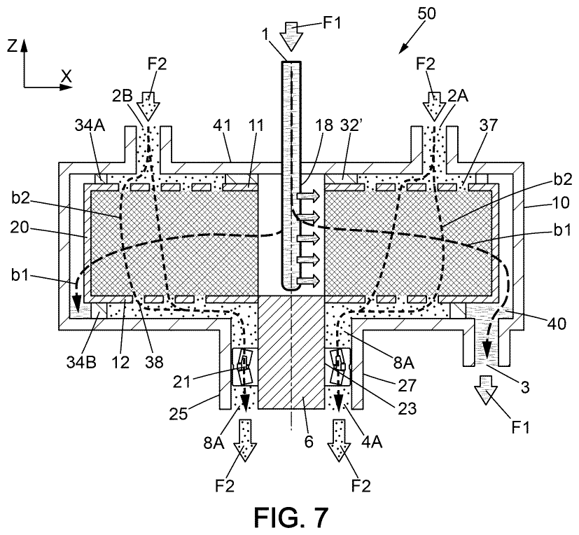

According to another embodiment, illustrated in FIG. 7, the flow of the first fluid F1 and of the second fluid F2 can be of the cross-current type, i.e. in transverse flow directions. The first fluid F1 flows in the packed bed 7 of the rotary contactor 5 in a radial direction, i.e. transversely to the direction of the axis of the rotary shaft 6.

The second fluid F2 flows through the packed bed 7 in an axial direction, i.e. parallel to the direction of the axis of the rotary shaft 6.

In this embodiment, the first inlet/outlet 2 is an inlet and the second inlet/outlet 4A is an outlet.

The rotary shaft 6 is a solid shaft.

The rotary shaft 6 extends along an axis D.

The rotary shaft 6 comprises a lateral surface 6L. This lateral surface 6L is an outer lateral surface.

The at least one flow channel 8A for the second fluid F2 is of cylindrical shape. The at least one flow channel 8A for the second fluid F2 extends along an axis D1.

The at least one flow channel 8A for the second fluid F2 and the rotary shaft 6 are coaxial here.

The space comprised between the lateral surface 6L of the rotary shaft 6 and the internal surface of the housing 27 is annular in shape.

The space comprised between the lateral surface 6L of the rotary shaft 6 and the internal surface of the housing 27 forms a portion of the at least one flow channel 8A.

The at least one flow channel 8A surrounds the rotary shaft 6.

The at least one second inlet/outlet 4A for the second fluid F2 forms one end of the at least one circulation channel 8A for the second fluid F2.

The rotary-bed device 50 comprises an enclosure 10 which forms a support member for holding the rotary contactor 5.

The enclosure 10 forms a frame relative to which the rotary contactor 5 can pivot.

The enclosure 10 is fixed.

The enclosure 10 forms a volume for receiving the rotary contactor 5.

The first fluid F1 and the second fluid F2 flow inside the enclosure 10.

The enclosure 10 is fluidtight.

The enclosure 10 contains the first fluid F1 and the second fluid F2.

The enclosure 10 is rigid.

Rigid is understood as meaning that the enclosure 10 undergoes only elastic, and thus reversible, deformations during nominal use of the rotary-bed device 50.

The housing 27 in which the rotary shaft 6 is arranged is formed in the enclosure 10. The lateral surface 6L of the rotary shaft 6 is in contact with the second fluid F2.

The inner lateral surface of the housing 27 is in contact with the second fluid F2.

A portion of the at least one flow channel 8A for the second fluid F2 extends axially between the packed bed 7 and a first axial end of the rotary shaft 6.

The rotary shaft 6 is configured to pivot relative to the enclosure 10 by means of at least one guide bearing.

According to the embodiments illustrated in FIGS. 1 to 7, the rotary shaft 6 is configured to pivot with respect to the housing 27 by means of at least one rolling bearing 21 arranged in the housing 27,
and said at least one rolling bearing 21 is arranged in said at least one flow channel 8A for the second fluid F2.

The at least one guide bearing for the rotary shaft 6 is thus a rolling bearing.

The rolling bearing may notably be a ball bearing or a roller bearing. The rolling bearing may comprise two rows of balls or two rows of rollers.

The moving elements of the rolling bearing 21 are in contact with the second fluid F2 when the rotary-bed device 50 is in operation. The second fluid F2 contributes to cooling the rolling bearing 21, making it possible to reduce the thermal stresses on the components of the rolling bearing 21. For certain chemical compositions of the second fluid F2, the circulation of the second fluid F2 also provides lubrication for the rolling bearing 21, thus improving its reliability.

The rolling bearing 21 may be a ball bearing or a roller bearing. The rolling bearing 21 may comprise two rows of balls or two rows of rollers.

The rolling bearing 21 comprises:
an inner ring 23 in which the rotary shaft 6 is arranged,
an outer ring 25 arranged in the housing 27,

and a portion of the at least one flow channel 8A extends radially between the rotary shaft 6 and the housing 27.

The inner ring 23 of the rolling bearing 21 is fixed with respect to the rotary shaft 6. The outer ring 25 of the rolling bearing 21 is fixed with respect to the inner wall of the housing 27 of the enclosure 10.

A portion of the at least one flow channel 8A extends axially between a first axial end of the at least one rolling bearing 21 and a second axial end of the at least one rolling bearing 21 and extends radially between the inner ring 23 and the outer ring 25 of the at least one rolling bearing 21.

In other words, the space axially comprised between a first axial end of the at least one rolling bearing 21 and a second axial end of the at least one rolling bearing 21, and comprised radially between the inner ring 23 and the outer ring 25, forms a portion of the at least one flow channel 8A.

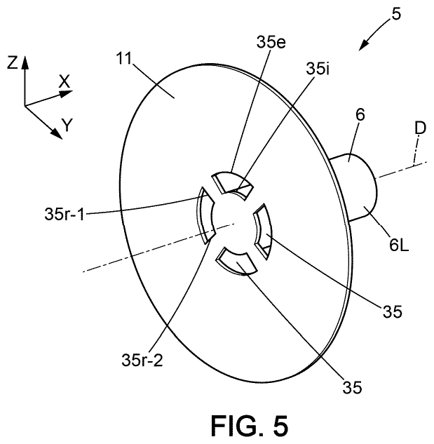

According to the embodiments of FIGS. 1 to 4 and according to the embodiment of FIG. 5, the rotary contactor 5 comprises:
a first end plate 11 and a second end plate 12, the first end plate 11 and the second end plate 12 extending transversely with respect to the rotary shaft 6, some distance apart from one another, the first end plate 11 being secured to the rotary shaft 6,
a mixing chamber 13 delimited in an axial direction by the two end plates 11, 12, the packed bed 7 being arranged in the mixing chamber 13,

and the first end plate 11 comprises at least one through-orifice 35 configured to allow fluid to pass between the packed bed 7 and said at least one flow channel 8A for the second fluid F2.

The mixing chamber 13 is filled by the packed bed 7.

The two end plates 11, 12 form a support, in an axial direction, for the packed bed 7.

Each end plate 11, 12 has the form of a disc which is hollow at its centre. The hollow is circular in shape and notably allows the insertion of the rotary shaft 6.

The two end plates 11, 12 are offset along the axis of the rotary shaft 6. The volume delimited by the two end plates 11, 12 is filled by the packed bed 7.

Each end plate 11, 12 comprises a radial-retention device for the packed bed 7. The retention device resists the centrifugal forces applied to the packed bed 7. This retention device has not been depicted.

The packed bed 7 is thus fixed with respect to the end plates 11, 12.

According notably to the embodiments of FIGS. 1 to 4, the at least one through-orifice 35 of the first end plate 11 opens into the at least one flow channel 8A for the second fluid F2.

The at least one through-orifice 35 of the first end plate 11 faces, in an axial direction, the at least one flow channel 8A for the second fluid F2.

The mixing chamber 13 comprises a radially inner edge 13-i and a radially outer edge 13-e, and is configured to allow:
the first fluid F1 to flow from the radially inner edge 13-i towards the radially outer edge 13-e.

The centrifugal force generated by the rotation of the rotary contactor 5 tends to cause the liquid F1 to pass from the region close to the axis D of the rotary shaft 6 towards the outer periphery of the packed bed 7.

The radially inner edge 13-i is the edge closest to the axis D of the rotary shaft 6. The radially outer edge 13-e is the edge furthest from the axis D of the rotary shaft 6.

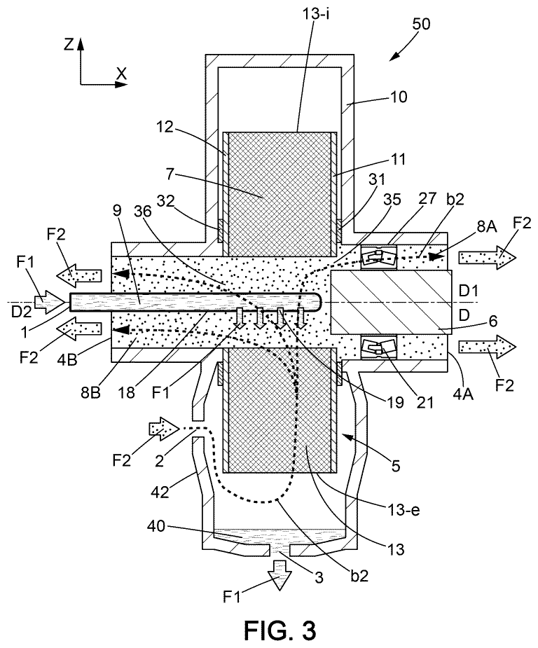

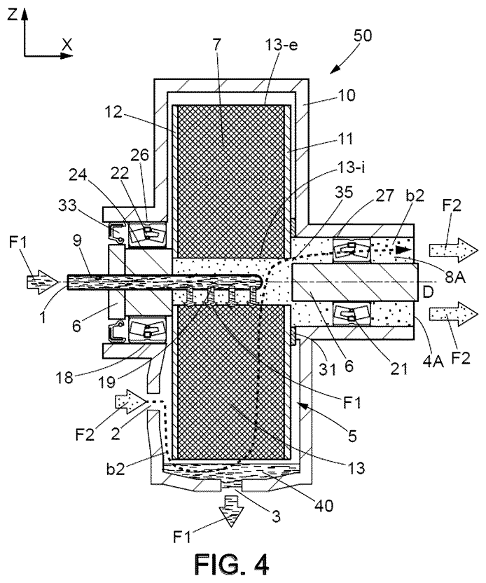

According to the embodiment in FIG. 1 and according to the embodiments in FIGS. 3 and 4, the liquid F1 and the gas F2 flow in a counter-current arrangement.

The mixing chamber 13 is thus configured to allow the second fluid F2 to flow from the radially outer edge 13-e towards the radially inner edge 13-i.

The first fluid F1 and the second fluid F2 thus have opposite directions of movement.

According to the embodiment in FIG. 2, the liquid F1 and the gas F2 flow in a co-current arrangement.

The mixing chamber 13 is configured to allow the second fluid F2 to flow from the radially inner edge 13-i towards the radially outer edge 13-e.

The first fluid F1 and the second fluid F2 thus have the same directions of movement through the packed bed 7.

According to the embodiment in FIG. 7, the liquid F1 and the gas F2 flow in a cross-current arrangement. This embodiment will be described later on.

FIG. 5 illustrates the rotary contactor 5 in detail.

A radially inner edge 35i of the at least one through-orifice 35 of the first end plate 11 is adjacent to the rotary shaft 6.

The first end plate 11 here comprises a set of through-orifices 35. More specifically, the first end plate 11 comprises four through-orifices 35.

The through-orifices 35 of the first end plate 11 are uniformly spaced.

The through-orifices 35 of the first end plate 11 are arranged at the same distance from the centre of the first end plate 11.

The through-orifices 35 of the first end plate 11 have the same shape. The through-orifices 35 of the first end plate 11 are bounded laterally by two rectilinear portions 35r-1, 35r-2.

The through-orifices 35 of the first end plate 11 are bounded radially by two circular-arc portions 35i, 35e.

The two circular-arc portions 35i, 35e have the same centre and this centre coincides with the centre of the first end plate 11.

Each rectilinear portion 35r-1, 35r-2 extends radially towards the centre of the first end plate 11. A first rectilinear portion 35r-1 connects a first end of the radially inner circular-arc portion 35i to a first end of the radially outer circular-arc portion 35e. The second rectilinear portion 35r-2 connects the second end of the radially inner circular-arc portion 35i to the second end of the radially outer circular-arc portion 35e.

The radius of the radially inner circular-arc portion 35i is substantially equal to the radius of the rotary shaft 6.

In the example illustrated, in which the first end plate 11 comprises four through-orifices 35, each through-orifice extends over an angular range comprised between 60° and 80°.

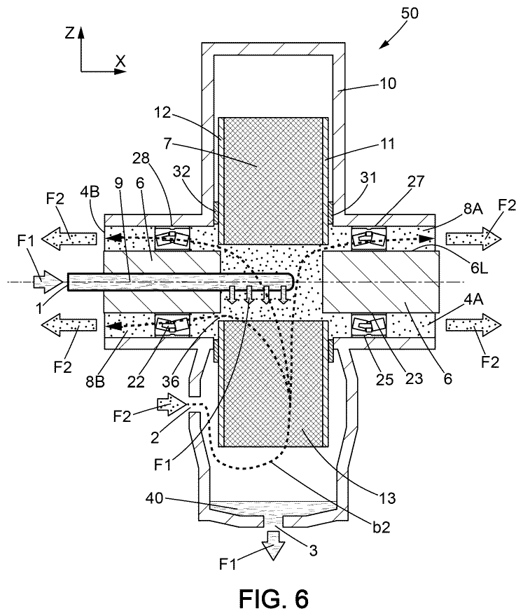

FIG. 3 and FIG. 6 schematically indicate embodiments in which the rotary-bed device 50 comprises more than one outlet for the second fluid F2.

The rotary-bed device 50 thus comprises:
a third inlet/outlet 4B for the second fluid F2,
a second flow channel 8B configured to make the second fluid F2 flow from the packed bed 7 towards the third inlet/outlet 4B for the second fluid F2, or to make the second fluid F2 flow from the third inlet/outlet 4B towards the packed bed 7.

The presence of a second flow channel 8B makes it possible to increase the flow cross section for the second fluid F2, and thus further reduce the drop in pressure. For the same amount of occupied space, the maximum flow rate of the rotary-bed device 50 can be increased.

The third inlet/outlet 4B for the second fluid F2 has the same role as the second inlet/outlet 4A. In other words, according to the embodiment in FIG. 3 and according to that of FIG. 5, the second inlet/outlet 4A and the third inlet/outlet 4B are jointly outlets for the second fluid F2. According to one embodiment (not depicted), the second inlet/outlet 4A and the third inlet/outlet 4B are jointly inlets for the second fluid F2.

The first flow channel 8A for the second fluid F2 and the second flow channel 8B for the second fluid F2 are in fluidic communication.

According to the embodiment of FIG. 6, the rotary-bed device 50 comprises a second housing 28 for receiving the rotary shaft 6,
and the second flow channel 8B for the second fluid F2 is arranged in a space radially to the outside of the rotary shaft 6 and radially to the inside of the second housing 28 for receiving the rotary shaft 6 of the rotary contactor 5.

According to this embodiment, the second end plate 12 comprises at least one through-orifice 36 configured to allow fluid to pass between the packed bed 7 and the second flow channel 8B for the second fluid F2.

The second flow channel 8B for the second fluid F2 is of cylindrical shape. The second flow channel 8B for the second fluid F2 extends along an axis D2. Said at least one flow channel 8A is referred to as “first outlet channel”.

The first flow channel 8A and the second flow channel 8B are arranged in an axial direction one on each side of the mixing chamber 13.

The first flow channel 8A and the second flow channel 8B are coaxial.

The first flow channel 8A and the second flow channel 8B can have the same diameter.

According to the embodiment of FIG. 3, the rotary shaft 6 extends axially on just one side of the mixing chamber 13.

The rotary-bed device 50 comprises at least one distributor 9 for the first fluid F1, allowing the first fluid F1 to be introduced into the rotary contactor 5.

In order to simplify the figures, the distributor 9 has not been depicted in FIGS. 1 and 2.

As schematically indicated in FIGS. 3 and 4, and in FIGS. 6 to 8, the at least one distributor 9 comprises a tubular portion 18.

The tubular portion 18 of said at least one distributor 9 and the rotary shaft 6 of the rotary contactor 5 are coaxial.

The at least one distributor 9 comprises at least one through-orifice 19 for the first fluid F1. According to the example illustrated, the at least one distributor 9 comprises a set of through-orifices 19 for the first fluid F1.

The at least one distributor 9 comprises a tubular portion 18.

The at least one through-orifice 19 for the first fluid F1 is formed in a side wall of the tubular portion 18.

The at least one through-orifice 19 is arranged facing the packed bed 7 in a radial direction.

The first fluid F1 leaves the at least one distributor 9 via the through-orifices 19, and reaches the packed bed 7 of the rotary contactor 5.

The through-orifices 19 are axially offset along the tubular portion 18 of the distributor 9. The through-orifices 19 are angularly offset along a part of the lateral surface of the tubular portion 18.

The distributor 9 may comprise several rows of through-orifices 19. Each row may comprise several through-orifices axially offset along the tubular portion.

The rows are distributed at regular angular intervals along the tubular portion. Each row forms a generatrix of the tubular portion.

For example, the distributor 9 comprises nine rows of through-orifices, distributed at an interval of 40° around the entire periphery of the tubular portion. Each row comprises for example three through-orifices.

The spacing between the first and the second orifice in a row is the same as the spacing between the second orifice and the third orifice of this row.

According to the embodiment of FIG. 4, the rotary-bed device 50 comprises at least one distributor 9 for the first fluid F1, configured to transfer the first fluid F1 from the inlet 1 for the first fluid F1 to the packed bed 7, and a portion of said at least one distributor 9 for the first fluid F1 is arranged inside the rotary shaft 6 of the rotary contactor 5.

The rotary shaft 6 is hollow over part of its length, and forms a receiving housing for a portion of the distributor 9.

According to the example illustrated, the end of the tubular portion 18 of the at least one distributor 9 for the first fluid F1 is closed.

According to a variant which is not depicted, the end of the tubular portion 18 of the at least one distributor 9 for the first fluid F1 is open.

The number of distributors in the rotary-bed device 50 may vary.

According to a variant which is not depicted, the rotary-bed device 50 comprises two distributors.

The two distributors are for example arranged parallel to one another inside the rotary contactor 5. The two distributors can be arranged symmetrically with respect to the axis D of the rotary shaft 6.

Each distributor delivers a portion of the total flow of the first fluid F1.

Several types of mechanical connection between the rotary shaft 6 of the rotary contactor 5 are possible. In particular, the number of guide bearings supporting the rotary shaft 6 differs according to the embodiment.

According to the embodiments in FIGS. 1 to 3, and according to the embodiment of FIG. 7, the rotary shaft 6 is configured to pivot relative to the enclosure 10 by means of a single guide bearing 21. The single guide bearing 21 may be a rolling bearing.

According to the embodiments of FIGS. 4 and 6, the rotary shaft 6 is configured to pivot relative to the enclosure 10 by means of at least a first guide bearing 21 and a second guide bearing 22. The first guide bearing 21 and the second guide bearing 22 can be rolling bearings. According to the embodiment of FIG. 6, the rotary shaft 6 is configured to pivot with respect to the second housing 28 by means of a second rolling bearing 22 arranged in the second housing 28,
and the second rolling bearing 22 is arranged in the second flow channel 8B for the second fluid F2.

The second rolling bearing 22 improves the guidance of the rotary shaft 6. As before, the second rolling bearing may notably be a ball bearing or a roller bearing, for example having two rows of balls or two rows of rollers.

The second housing 28 in which the second rolling bearing 22 is arranged is formed in the enclosure 10.

The space comprised between the lateral surface of the rotary shaft 6 and the internal surface of the second housing 28 is annular in shape.

The space comprised between the outer lateral surface of the rotary shaft 6 and the internal surface of the second housing 28 forms a portion of the second flow channel 8B.

The first rolling bearing 21 and the second rolling bearing 22 are arranged one on each side of the mixing chamber 13 in an axial direction.

The second rolling bearing 22 and the first rolling bearing 21 may be identical.

The rotary-bed device 50 may thus exhibit symmetry about a plane transverse to the axis D of the rotary shaft 6. This makes it easier for the second fluid F2 to flow.

The second rolling bearing 22 comprises:
an inner ring 24 in which the rotary shaft 6 is arranged,
an outer ring 26 arranged in the second housing 28,
and a portion of the second flow channel 8B extends radially between the rotary shaft 6 and the second housing 28.

The inner ring 24 of the second rolling bearing 22 is fixed with respect to the rotary shaft 6. The outer ring 26 of the second rolling bearing 22 is fixed with respect to the inner wall of the second housing 28 of the enclosure 10.

The second flow channel 8B for the second fluid F2 is coaxial with the rotary shaft 6. The first flow channel 8A for the second fluid F2 and the second flow channel 8B for the second fluid F2 are thus coaxial.

According to the embodiment of FIG. 4 and according to that of FIG. 6, the second end plate 12 is secured to the rotary shaft 6.

The rotary shaft 6 comprises two portions that are disjointed and offset from one another in an axial direction. The two portions are separated by the end plates 11, 12 and by the mixing chamber 13. The two portions of the rotary shaft 6 may have the same diameter.

The at least one through-orifice 36 of the second end plate 12 opens into the second flow channel 8B for the second fluid F2.

The second through-orifice 36 faces, in an axial direction, the second flow channel 8B for 20 the second fluid F2.

A radially inner edge of the at least one through-orifice 36 of the second end plate 12 is adjacent to the rotary shaft 6.

The through-orifices 36 of the second end plate 12 may have the same shape as the through-orifices 35 of the first end plate 11.

The through-orifices 36 of the second end plate 12 may have the same flow cross section as the through-orifices 35 of the first end plate 11.

The first end plate 11 and the second end plate 12 may be symmetrical with respect to one another.

FIG. 7 schematically indicates an embodiment in which the flow of the first fluid F1 and of the second fluid F2 is of the cross-current type.

According to this embodiment, the rotary contactor 5 comprises:
a first end plate 11 and a second end plate 12, the first end plate 11 and the second end plate 12 extending transversely with respect to the rotary shaft 6, some distance apart from one another, the first end plate 11 being secured to the rotary shaft 6,
a mixing chamber 13 delimited in an axial direction by the two end plates 11, 12, the packed bed 7 being arranged in the mixing chamber 13.

The first end plate 11 comprises at least one through-orifice 37 configured to allow fluid to pass between the at least one first inlet/outlet 2 for the second fluid F2 and the packed bed 7, and the second end plate 12 comprises at least one through-orifice 38 configured to allow fluid to pass between the packed bed 7 and said at least one flow channel 8A for the second fluid F2.

More specifically, the first end plate 11 comprises a set of through-orifices 37, and the second end plate 12 comprises a set of through-orifices 38.

The set of through-orifices 37 of the first end plate 11 is arranged on a first lateral surface of the packed bed 7. The set of through-orifices 38 of the second end plate 12 is arranged on a second lateral surface of the packed bed 7, this being the opposite surface to the first lateral surface.

The flow of the second fluid F2 is of the cross-current type.

Specifically, the flow of the first fluid F1 is identical to that of the other embodiments, namely the first fluid F1 flows radially from the at least one outlet 19 of the distributor 9 towards the outer peripheral edge of the rotary contactor 5.

The rotary-bed device 50 comprises two distinct inlets 2A, 2B for the second fluid F2. The two inlets 2A, 2B face the first end plate 11.

The flow of the second fluid F2 is axial, namely the second fluid F2 is admitted into the rotary contactor 5 via a first lateral face of the rotary contactor 5, and leaves the rotary contactor 5 via the second lateral face of the rotary contactor 5 which is the opposite face to the first lateral face.

The second fluid F2 leaving the rotary contactor 5 flows into the volume comprised between the inner wall of the enclosure 10 and the lateral surface of the rotary contactor 5, and reaches the flow channel 8A which in this instance is an outlet channel.

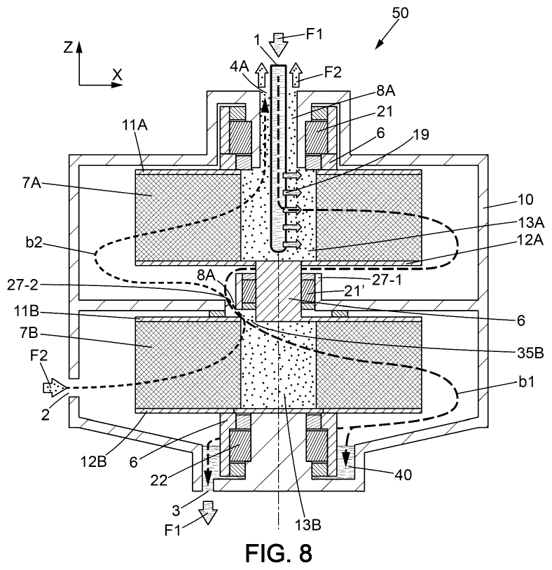

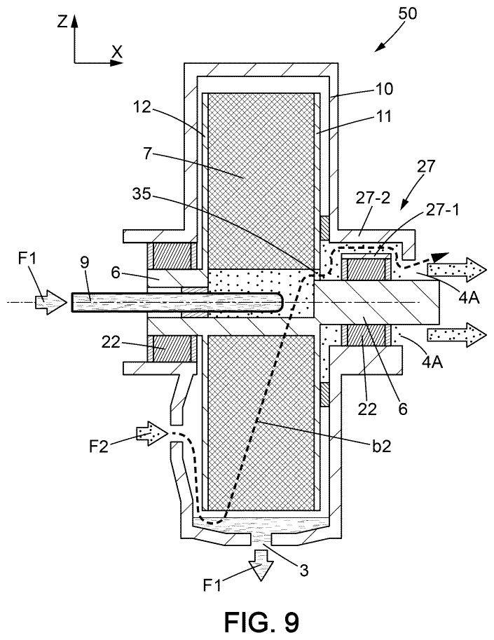

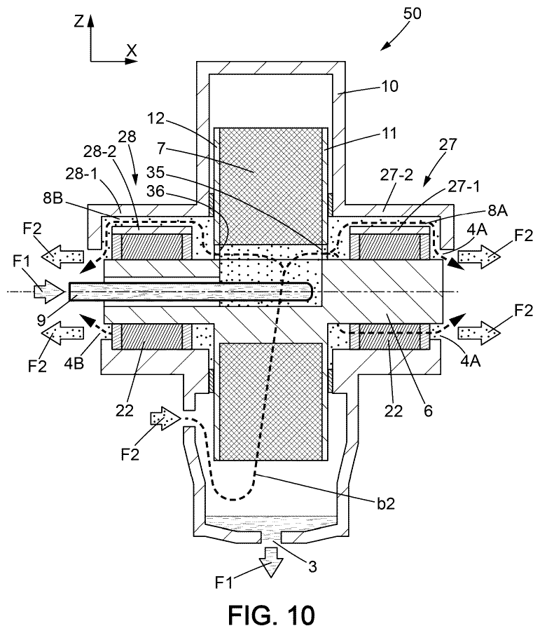

FIG. 8 schematically indicates an embodiment in which the rotary-bed device 50 comprises two packed bed stages.

According to this embodiment of the rotary-bed device 50, the rotary contactor 5 comprises:
a rotary shaft 6,
a first packed bed 7A, secured to the rotary shaft 6, and configured to allow a transfer of material or a transfer of heat between the first fluid F1 and the second fluid F2,
a second packed bed 7B, secured to the rotary shaft 6, and configured to allow a transfer of material or a transfer of heat between the first fluid F1 and the second fluid F2,

an outlet of the first packed bed 7A being configured to supply a flow of the first fluid F1 to the second packed bed 7B,

an outlet of the second packed bed 7B being configured to supply a flow of the second fluid F2 to the first packed bed 7A,
a first flow channel 8A for the second fluid F2, configured to make the second fluid F2 flow from the first packed bed 7A towards the second inlet/outlet 4A for the second fluid F2,
a second flow channel 8B for the second fluid F2, configured to make the second fluid F2 flow from the second packed bed 7B towards the first packed bed 7A,
   at least a housing 27 to receive the rotary shaft 6,

wherein said at least one second flow channel 8B for the second fluid F2 is arranged in a space radially to the outside of the rotary shaft 6 and radially to the inside of the housing 27 receiving the rotary shaft 6 of the rotary contactor 5.

The rotary contactor 5 comprises a first packed bed 7A and a second packed bed 7B rigidly connected to the first packed bed 7A. The first packed bed 7A is held in place by two end plates 11A, 11B. The second packed bed 7B is held in place by two end plates 12A, 12B.

The end plate 12A of the first packed bed 7A is connected to the end plate 11B of the second packed bed 7B by a portion of the rotary shaft 6.

The end plate 11B of the second packed bed 7B comprises at least one through-opening 35B, preferably a set of through-openings 35B.

The first packed bed 7A and the second packed bed 7B may have the same dimensions.

The first fluid F1 leaves the orifices 19 of the distributor 9, flows in the first packed bed 7A and re-emerges via the periphery of the first packed bed 7A. The first fluid F1 then reaches the second packed bed 7B by passing through the through-orifices 35B of the end plate 11B. The first fluid F1 then flows in the second packed bed 7B and reaches the outlet 3.

The second fluid F2 is admitted via the inlet 2, passes through the second packed bed 7B and re-emerges via the through-openings 35B. The second fluid F2 flows in the space radially comprised between the rotary shaft 6 and the housing 27, this space forming a portion of a flow channel 8A. More specifically, the rotary shaft 6 is supported, in its part connecting the first packed bed 7A to the second packed bed 7B, by an intermediate bearing 21′.

The housing 27 comprises a first wall 27-1 in which the intermediate guide bearing 21′ is housed, and a second wall 27-2 radially to the outside of the first wall 27-1, surrounding the shaft 6.

The flow channel 8A for the second fluid F2 is arranged in part in a space radially to the outside of the first wall 27-1 and radially to the inside of the second wall 27-2. In other words, a portion of the flow channel 8A for the second fluid F2 is formed here by the space comprised between the wall 27-1 receiving the intermediate bearing 21′ and the wall 27-2 surrounding the rotary shaft 6 and the first wall 27-1. This portion allows the second fluid F2 to pass from the second packed bed 7B to the first packed bed 7A.

The second fluid F2 then reaches the outer peripheral edge of the first packed bed 7A, flows in the first packed bed 7A and exits via the outlet 4A. The outlet 4A here is radially to the inside of the rotary shaft 6 which is hollow in its upper part. The upper part of the flow channel 8A thus is arranged inside the rotary shaft 6.

The rotary-bed device 50 comprises a set of seals. p According to the embodiments illustrated in FIGS. 1 to 4, and according to the embodiment of FIG. 6, the rotary-bed device 50 comprises a first seal 31 arranged in an axial direction between the first end plate 11 of the rotary contactor 5 and the enclosure 10. The first seal 31 surrounds the at least one flow channel 8A.

The first seal 31 isolates the at least one flow channel 8A from that part of the enclosure 10 that is comprised to the outside of the rotary contactor 5.

According to the embodiments illustrated in FIGS. 1 to 3, the rotary-bed device 50 comprises a second seal 32 arranged in an axial direction between the second end plate 12 of the rotary contactor 5 and the enclosure 10.

In the case of the third embodiment illustrated in FIG. 3, the second seal 32 surrounds the second outlet channel 8B.

The second seal 32 isolates the second flow channel 8B from that part of the enclosure 10 that is comprised to the outside of the rotary contactor 5.

The first seal 31 and the second seal 32 are annular in shape.

The first seal 31 and the second seal 32 provide dynamic sealing between the end plates 11, 12 of the rotary contactor 5 and the enclosure 10, so as to prevent fluids comprised between the end plates 11, 12 of the rotary contactor 5 and the internal walls of the enclosure 10 from reaching the flow channels 8A, 8B, which are then outlet channels, without passing through the orifices 35, 36 of the end plates 11, 12.

According to the fourth embodiment, illustrated in FIG. 4, the rotary-bed device 50 comprises a third seal 33 arranged radially between a portion of the rotary shaft 6 and part of the enclosure 10.

The third seal 33 isolates the rotary contactor 5 from the outside of the enclosure 10. The third seal 33 provides dynamic sealing between the rotary shaft 6 of the rotary contactor 5 and the enclosure 10. The third seal 33 prevents the first fluid F1 and the second fluid F2 from leaving the enclosure 10 by passing through the second rolling bearing 22.

In the embodiment of FIG. 7, a seal 32′ is arranged between the first end plate 11 and the enclosure 10 at the radially inner edge of the first end plate 11.

A seal 34A is arranged between the first end plate 11 and the enclosure 10 at the radially outer edge of the first end plate 11.

A seal 34B is arranged between the second end plate 12 and the enclosure 10 at the radially outer edge of the second end plate 12.

The seals 34A, 34B prevent the second fluid F2 from being able to pass from one of the inlets 2A, 2B to the second inlet/outlet 4A without flowing in the packed bed 7 of the rotary contactor 5.

FIG. 9 depicts an embodiment in which the flow channel 8A for the second fluid F2 passes around a guide bearing 21 for the rotary shaft 6.

FIG. 10 depicts a variant of the embodiment of FIG. 9, in which the rotary-bed device 50 comprises two flow channels 8A, 8B for the second fluid F2 and two outlets 4A, 4B, each flow channel 8A, 8B passing around a respective guide bearing 21, 22 for the rotary shaft 6.

According to the embodiment of FIG. 9, the housing 27 comprises a first wall 27-1 forming a retaining housing for a guide bearing 21 for the rotary shaft 6 and a second wall 27-2 radially to the outside of the first wall 27-1.

Said at least one flow channel 8A for the second fluid F2 is arranged in part in a space radially to the outside of the first wall 27-1 of the housing 27 and radially to the inside of the second wall 27-2 of the housing 27.

In other words, the flow channel 8A for the second fluid F2 is arranged between the first wall 27-1 providing retention for the guide bearing for the shaft, and the second wall 27-2, which surrounds the rotary shaft 6, the guide bearing 21, and the first wall 27-1. The second wall 27-2 is further from the axis of the rotary shaft 6 than the first wall 27-1, and the empty space separating the two walls forms part of the flow channel 8A.

Each axial end of the guide bearing comprises a seal. The guide bearing 21 is thus not in contact with the second fluid F2.

A first face of the first wall 27-1, this being a radially inner face, is in contact with the bearing 21. A second face of the first wall 27-1, this being a radially outer face that is the opposite face to the first face, delimits a radially inner edge of the flow channel 8A.

One face of the second wall 27-2, arranged facing the second face of the first wall 27-1, delimits a radially outer edge of the flow channel 8A.

The second fluid F2 flows parallel to the axis of the rotary shaft 6 along part of the flow channel 8A.

This embodiment makes it possible to avoid components of the guide bearing 21 coming into contact with a corrosive fluid, when the second fluid F2 is corrosive.

In the embodiment of FIG. 9, the rotary-bed device comprises a single outlet 4A and two guide bearings 21, 22 arranged axially along the rotary shaft 6 one on each side of the mixing chamber 13.

In the embodiment of FIG. 10, the rotary-bed device 50 comprises a second housing 28 for receiving the rotary shaft 6, and a second outlet 8B for the second fluid F2.

The second housing 28 comprises a first wall 28-1 forming a retaining housing for a second guide bearing 22 for the rotary shaft 6 and a second wall 28-2 radially to the outside of the first wall 28-1, and
the second flow channel 8B for the second fluid F2 is arranged in part in a space radially to the outside of the first wall 28-1 of the second housing 28 and radially to the inside of the second wall 28-2 of the second housing 28.

The creation of the second flow channel 8B is thus similar to that described in respect of the first channel 8A.

The presence of a second outlet 8B makes it possible to reduce the drop in pressure experienced by the second fluid F2, particularly the drop in pressure in that portion of the circuit that is comprised between the inner edge of the packed bed 7 and each outlet 8A, 25 8B.

The spatial orientation of the rotary contactor 5 may vary according to the embodiment.

According to the embodiments of FIGS. 1 to 4, and according to the embodiment of FIG. 6, the rotary shaft 6 is oriented in a horizontal direction X.

That means that the axis of the rotary shaft 6 is horizontal when the rotary-bed device 50 is in a nominal operating position.

The at least one first inlet/outlet 2 for the second fluid F2 is arranged on a side face 42 of the enclosure 10.

The outlet 3 for the first fluid F1 and the at least one second inlet/outlet 4A for the second fluid F2 extend in perpendicular planes.

The outlet 3 for the first fluid F1 is arranged in a lower portion of the enclosure 10. A lower portion of the enclosure 10 forms a collection volume 40 for the first fluid F1.

The collection volume 40 forms a liquid accumulation zone. The collection volume 40 communicates with the outlet 3 for the first fluid F1.

The at least one first inlet/outlet 2 for the second fluid F2 is arranged in a portion of the enclosure 10 arranged facing an end plate 11 of the rotary contactor 5.

According to the embodiments illustrated in FIGS. 7 and 8, the rotary shaft 6 is oriented in a vertical direction Z.

According to variants which are not depicted, the rotary shaft 6 can form any angle with the vertical axis.

In other words, the rotary shaft 6 can be oriented in any orientation comprised between a vertical orientation and a horizontal orientation.

Other embodiments and variants, which have not been depicted, may be implemented. In particular, the rotary-bed device may comprise several outlets for the first fluid F1.

The rotary-bed device may comprise more than two packed beds.

The rotary-bed device may comprise two distributors, for example two distributors arranged parallel to one another.

The rotary-bed device of FIG. 9 and that of FIG. 10 may be oriented vertically, by adapting the arrangement of the outlet 3 for the first fluid F1.

1. A rotary-bed device (50), comprising:
at least one inlet (1) for a first fluid (F1),
at least a first inlet/outlet (2) for a second fluid (F2),
at least one outlet (3) for the first fluid (F1),
at least a second inlet/outlet (4A) for the second fluid (F2),
a rotary contactor (5), comprising:
a rotary shaft (6), and
a packed bed (7), secured to the rotary shaft (6), and configured to allow a transfer of material or transfer of heat between the first fluid (F1) and the second fluid (F2),
at least one flow channel (8A) for the second fluid (F2), configured to make the second fluid (F2) flow from the packed bed (7) to said at least one second inlet/outlet (4A) for the second fluid (F2) or to make the second fluid (F2) flow from said at least one second inlet/outlet (4A) for the second fluid (F2) to the packed bed (7), and
at least a housing (27) to receive the rotary shaft (6),
wherein said at least one flow channel (8A) for the second fluid (F2) is arranged in a space radially to the outside of the rotary shaft (6) and radially to the inside of the housing (27) receiving the rotary shaft (6) of the rotary contactor (5).

2. The rotary-bed device (50) according to claim 1, wherein the rotary shaft (6) is configured to pivot with respect to the housing (27) by means of at least one rolling bearing (21) arranged in the housing (27), and
wherein said at least one rolling bearing (21) is arranged in said at least one flow channel (8A) for the second fluid (F2).

3. The rotary-bed device (50) according to claim 1, wherein the housing (27) comprises a first wall (27-1) forming a retaining housing for a guide bearing (21) for the rotary shaft (6) and a second wall (27-2) radially to the outside of the first wall (27-1), and
wherein said at least one flow channel (8A) for the second fluid (F2) is arranged in part in a space radially to the outside of the first wall (27-1) of the housing (27) and radially to the inside of the second wall (27-2) of the housing (27).

4. The rotary-bed device (50) according to claim 1, wherein the rotary contactor (5) further comprises:
a first end plate (11) and a second end plate (12), the first end plate (11) and the second end plate (12) extending transversely with respect to the rotary shaft (6), some distance apart from one another, the first end plate (11) being secured to the rotary shaft (6), and
a mixing chamber (13) delimited in an axial direction by the two end plates (11, 12), the packed bed (7) being arranged in the mixing chamber (13),
wherein the first end plate (11) comprises at least one through-orifice (35) configured to allow fluid to pass between the packed bed (7) and said at least one flow channel (8A) for the second fluid (F2).

5. The rotary-bed device (50) according to claim 1, further comprising:
a third inlet/outlet (4B) for the second fluid (F2),
a second flow channel (8B) configured to make the second fluid (F2) flow from the packed bed (7) towards the third inlet/outlet (4B) for the second fluid (F2), or to make the second fluid (F2) flow from the third inlet/outlet (4B) towards the packed bed (7).

6. The rotary-bed device (50) according to claim 4, further comprising:
a third inlet/outlet (4B) for the second fluid (F2),
a second flow channel (8B) configured to make the second fluid (F2) flow from the packed bed (7) towards the third inlet/outlet (4B) for the second fluid (F2), or to make the second fluid (F2) flow from the third inlet/outlet (4B) towards the packed bed (7), and
wherein the second end plate (12) comprises at least one through-orifice (36) configured to allow fluid to pass between the packed bed (7) and the second flow channel (8B) for the second fluid (F2).

7. The rotary-bed device (50) according to claim 6, further comprising a second housing (28) for receiving the rotary shaft (6),
wherein the second flow channel (8B) for the second fluid (F2) is arranged in a space radially to the outside of the rotary shaft (6) and radially to the inside of the second housing (28) for receiving the rotary shaft (6) of the rotary contactor (5).

8. The rotary-bed device (50) according to claim 7, wherein the rotary shaft (6) is configured to pivot with respect to the housing (27) by means of at least one rolling bearing (21) arranged in the housing (27), and
wherein said at least one rolling bearing (21) is arranged in said at least one flow channel (8A) for the second fluid (F2),
wherein the rotary shaft (6) is configured to pivot with respect to the second housing (28) by means of a second rolling bearing (22) arranged in the second housing (28), and
wherein the second rolling bearing (22) is arranged in the second flow channel (8B) for the second fluid (F2).

9. The rotary-bed device (50) according to claim 8, wherein the first rolling bearing (21) and the second rolling bearing (22) are arranged in an axial direction one on each side of the mixing chamber (13).

10. The rotary-bed device (50) according to claim 7, wherein the second housing (28) comprises a first wall (28-1) forming a retaining housing for a second guide bearing (22) for the rotary shaft (6) and a second wall (28-2) radially to the outside of the first wall (28-1), and
wherein the second flow channel (8B) for the second fluid (F2) is arranged in part in a space radially to the outside of the first wall (28-1) of the second housing (28) and radially to the inside of the second wall (28-2) of the second housing (28).

11. The rotary-bed device (50) according to claim 4, wherein the second end plate (12) is secured to the rotary shaft (6).

12. The rotary-bed device (50) according to claim 1, wherein the rotary contactor (5) further comprises:
a first end plate (11) and a second end plate (12), the first end plate (5 11) and the second end plate (12) extending transversely with respect to the rotary shaft (6), some distance apart from one another, the first end plate (11) being secured to the rotary shaft (6),
a mixing chamber (13) delimited in an axial direction by the two end plates (11, 12), the packed bed (7) being arranged in the mixing chamber (13),
wherein:
the first end plate (11) comprises at least one through-orifice (37) configured to allow fluid to pass between the at least one first inlet/outlet (2) for the second fluid (F2) and the packed bed (7), and
the second end plate (12) comprises at least one through-orifice (38) configured to allow fluid to pass between the packed bed (7) and said at least one flow channel (8A) for the second fluid (F2).

13. The rotary-bed device (50) according to claim 1, comprising a distributor (9) for the first fluid (F1), configured to transfer the first fluid (F1) from the inlet (1) for the first fluid (F1) to the packed bed (7), wherein a portion of the distributor (9) for the first fluid (F1) is disposed inside the rotary shaft (6) of the rotary contactor (5).

14. The rotary-bed device (50) according to claim 13, wherein the distributor (9) comprises a tubular portion (18), and wherein the tubular portion (18) of the distributor (9) and the rotary shaft (6) of the rotary contactor (5) are coaxial.

15. A process of using the rotary-bed device claim 1, comprising:
transferring material and/or heat is/are from one of the two fluids to the other fluid, the two fluids being both liquids or one being a liquid and the other being a gas.
